(19) United States
(12) Patent Application Publication
(10) Pub. No.: US 2022/0033129 A1
(43) Pub. Date: Feb. 3, 2022

(54) DOUBLE-WALL PAPERBOARD CONTAINERS HAVING AQUEOUS BARRIER COATINGS

(71) Applicant: WestRock MWV, LLC, Atlanta, GA (US)

(72) Inventors: Jiebin Pang, Glen Allen, VA (US); Timothy R. McNeal, Richmond, VA (US); Natasha G. Melton, Richmond, VA (US); Brian K. Knapp, West Point, VA (US)

(21) Appl. No.: 17/390,537

(22) Filed: Jul. 30, 2021

Related U.S. Application Data
(60) Provisional application No. 63/059,348, filed on Jul. 31, 2020.

(51) Int. Cl. B65D 3/22; B31B 50/74; B65D 3/06; D21H 19/40; D21H 19/82; D21H 19/38; D21H 27/32

(52) U.S. Cl. CPC B65D 3/22; B31B 50/747; B65D 3/06; B32B 7/14; D21H 19/822; D21H 19/385; D21H 1/04; D21H 19/40

(57) ABSTRACT

A coated paperboard container includes an inner paperboard substrate, an outer paperboard substrate, a first aqueous barrier coating located on the inner paperboard substrate, and a second aqueous barrier coating located on the outer paperboard substrate. The inner paperboard substrate and the outer paperboard substrate are coupled with an adhesive. The first aqueous barrier coating and the second aqueous barrier coating include a pigment and a binder and the first aqueous barrier coating is heat sealable.

### FIELD

The present application relates to the field of coated paperboard containers and, more particularly, coated paperboard containers having an aqueous barrier coating.

### BACKGROUND

Paperboard is used in various packaging applications, such as containers. For example, paperboard is used in the food and beverage industry to form paperboard cups for holding hot or cold beverages.

Paperboard cups for holding hot beverages typically require enhanced liquid barrier properties on an interior surface of the cup to minimize absorption of liquid from the beverage into the paperboard substrate. Paperboard cups for holding cold beverages typically require enhanced liquid barrier properties on an interior surface of the cup to minimize absorption of liquid from the beverage into the paperboard substrate and on an exterior surface of the cup to minimize absorption of liquid from condensate into the paperboard substrate.

The paperboard is typically heat sealable, making it possible to form paperboard cups on a cup machine. Polyethylene (PE) extrusion coated paperboard currently still dominates in such applications by providing both good barrier and good heat sealing properties. However, such paperboard cups having a polyethylene extrusion coating have difficulties in recycling and repulping due to difficulty of breaking down the polyethylene film during the re-pulping process, and, thus, are not easily recyclable, causing environmental concerns. Thus, there are increasing demands for alternative solutions including new coating technologies to replace polyethylene extrusion coated paperboard cups.

Further, many paperboard containers that do not have a polyethylene coating can experience problems with liquid penetration. Liquid penetration can compromise structural integrity of the paperboard container, stain the inner surface of the container, and stain the outer surface of the container. The structural and staining issues may be exacerbated under conditions of elevated temperature, increased air flow, or when aggressive additives are placed in the container such as acidic soda drinks.

Accordingly, those skilled in the art continue with research and development in the field of coated paperboard containers.

### SUMMARY

In one example, a coated paperboard container includes an inner paperboard substrate, an outer paperboard substrate, a first aqueous barrier coating located on the inner paperboard substrate, and a second aqueous barrier coating located on the outer paperboard substrate. The inner paperboard substrate and the outer paperboard substrate are coupled with an adhesive. The first aqueous barrier coating and the second aqueous barrier coating include a pigment and a binder, and the first aqueous barrier coating is heat sealable.

In one example, a method of manufacturing a double-wall cup having an inner paperboard substrate coated with a first aqueous barrier coating and an outer paperboard substrate coated with a second aqueous barrier coating includes forming a cup structure with the inner paperboard substrate, applying an adhesive to the cup structure, and overwrapping the cup structure with the outer paperboard substrate.

In one example, a double wall cup includes an inner paperboard substrate, an outer paperboard substrate, a first aqueous barrier coating located on the inner paperboard substrate, a second aqueous barrier coating located on the outer paperboard substrate, and an adhesive located between the inner paperboard substrate and the outer paperboard substrate.

### BRIEF DESCRIPTION OF THE DRAWINGS

FIG. 1 is an elevational view, in section, of one aspect of the disclosed paperboard-based container;

FIG. 2 is a cross-sectional view of the double-wall paperboard structure forming the side wall of the paperboard-based container of FIG. 1;

FIG. 3 is a cross-sectional view of a double-wall paperboard structure that may be used as an alternative to the paperboard structure shown in FIG. 2;

FIG. 4 is a cross-sectional view of a double-wall paperboard structure that may be used as an alternative to the paperboard structure shown in FIG. 2;

FIG. 5 is a cross-sectional view of a double-wall paperboard structure that may be used as an alternative to the paperboard structure shown in FIG. 2;

FIG. 6 is a cross-sectional view of a double-wall paperboard structure that may be used as an alternative to the paperboard structure shown in FIG. 2;

FIG. 7 is a flowchart of a method of manufacturing a double-wall cup;

FIG. 8 is an illustration of the inside surfaces of three cups after experimental trials;

FIG. 9 is an illustration of the outside surfaces of three cups after experimental trials; and

FIG. 10 is an illustration of the inside surfaces of two cups after experimental trials.

### DETAILED DESCRIPTION

Sustainability is a key driver in development of new packaging containers for food products. Paperboard with a low-density polyethylene (LDPE) extrusion coating is typically used in the food industry. These coatings are not easily recyclable, however, and thus raise environmental concerns. Paperboard coated with aqueous coatings is generally considered recyclable and thus more sustainable, but typically does not yield the same structural properties as paperboard coated in LDPE. In particular, paperboard with an aqueous coating typically yields inferior level of liquid holdout when compared with containers of LDPE coated paperboard.

Many beverages, such as coffee, soda, sports drinks, etc. contain oils and surfactants that can damage and penetrate aqueous barrier coating layers through the paperboard wall. Creating a thicker structure with additional barriers may stop or significantly delay the degradation process and thus extend the life of a paperboard container by modifying the liquid absorption and transmission mechanism. One example for modification of the liquid absorption and transmission mechanism is use of an overwrap. Another example includes use of a low vapor-transmission-rate coating on the outside wall of a single-wall container.

In an example, present description relates to a coated paperboard container having a side wall comprised of an inner paperboard substrate and an outer paperboard substrate, otherwise referred to as an overwrap. The inner paperboard substrate and outer paperboard substrate each have an aqueous barrier coating, with excellent performance and properties. The aqueous barrier coatings easily break down during repulping and, thus, are more easily repulpable than paperboard containers having a polyethylene extrusion coating. Further, the coated paperboard container of the present description exhibits significantly improved performance and properties over the conventional aqueous barrier coated paperboard cups. Aqueous barrier coated paperboard containers having different coating structures and configurations were tested and evaluated for a wide range of properties and performance.

In an example, the coated paperboard container further includes a bottom wall that includes a bottom stock paperboard substrate and an aqueous barrier coating on the interior surface of the bottom stock paperboard substrate, in which a circumferential portion of the bottom stock paperboard substrate is heat sealed, by way at least one of the aqueous barrier coating of the sidewall and the aqueous barrier coating of the bottom wall, to a lower end of the sidewall paperboard substrate. Details of the testing and evaluation methods are described herein.

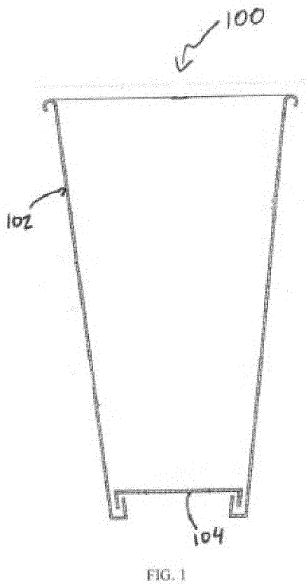

FIG. 1 illustrates an exemplary embodiment of a paperboard container 100. In an example, the paperboard container 100 is a cup. Paperboard container 100 may include a sidewall 102 and a bottom wall 104. The sidewall 102 may include an inner paperboard substrate 110 and an outer paperboard substrate 120. Inner paperboard substrate 110 and outer paperboard substrate 120 may be bleached or unbleached. Examples of appropriate paperboard substrates include corrugating medium, linerboard, solid bleached sulfate (SBS), unbleached kraft, and folding boxboard (FBB). In an example, the inner paperboard substrate 110 and outer paperboard substrate 120 may comprise 18 pt, 185 lb·3000 ft² TruServ™ Cupstock. In an example, the bottom wall 104 may comprise 13 pt, 150 lb/3000 ft², TruServ™ Cupstock. In an example, the bottom wall 104 may comprise 11 pt, 140 lb/3000 ft², TruServ™ Cupstock.

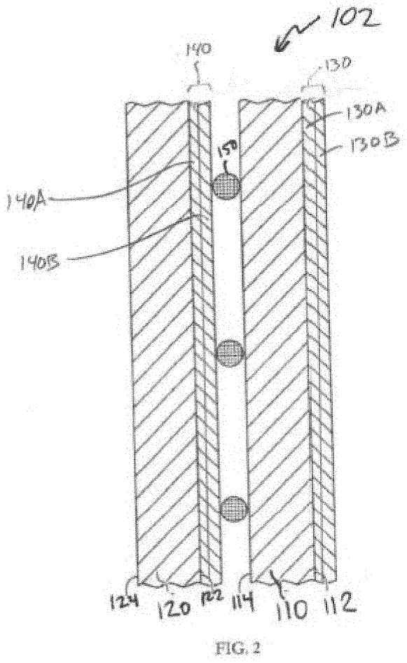

FIG. 2 illustrates an exemplary embodiment of a cross-sectional view of a sidewall 102 of a paperboard container 100. In an example, sidewall 102 is comprised of an inner paperboard substrate 110 and an outer paperboard substrate 120. Inner paperboard substrate 110 may be coated with a first aqueous barrier coating 130. The first aqueous barrier coating 130 may be located on an inside surface 112 of the inner paperboard substrate 110. Outer paperboard substrate 120 may be coated with a second aqueous barrier coating 140. Second aqueous barrier coating 140 may be located on an interior surface 122 of outer paperboard substrate 120. In an example, first aqueous barrier coating 130 is heat sealable. When heated, a heat sealable coating provides an adhesion to other regions of product with which it contacts.

An adhesive 150 may be located between inner paperboard substrate 110 and outer paperboard substrate 120. Adhesive 150 may be configured to couple inner paperboard substrate 110 with outer paperboard substrate 120. In an example, adhesive 150 is glue. Adhesive 150 may be applied in generally circular drops along an outside surface 114 of the inner paperboard substrate 110. In an example, adhesive 150 may be applied as a single layer along outside surface 114 of the inner paperboard substrate 110.

First aqueous barrier coating 130 and second aqueous barrier coating 140 may include a pigment and a binder. In one expression, the ratio of the binder to the pigment can be at least about 1:2 by weight. In another expression, the ratio of the binder to the pigment can be about 1:2 to about 9:1 by weight. In another expression, the ratio of the binder to the pigment can be about 1:1 to about 4:1 by weight. In yet another expression, the ratio of the binder to the pigment can be at least about 1:1 by weight.

In an example, the pigment may include calcium carbonate (CaCO₃) pigment. In an example, the CaCO₃ pigment can be a coarse ground CaCO₃ with a particle size distribution wherein about 60 percent of the particles are less than 2 microns. In an example, the CaCO₃ pigment can be a fine ground CaCO₃ with a particle size distribution wherein about 90 percent of the particles are less than 2 microns. In an example, the CaCO₃ pigment can be a fine ground CaCO₃ with a mean particle size of about 0.4 microns. In an example, the pigment may be a platy clay having a high aspect ratio. In an example, the first aqueous barrier coating 130 and second aqueous barrier coating 140 may include any combination of pigments described herein, including a combination of a calcium carbonate pigment and clay pigment.

The binder may be a water-based acrylic emulsion polymer having a glass transition temperature, T_{g}, of approximately 30° C. In an example, the binder may be a water-based styrene-acrylic latex polymer having a T_{g} of approximately 8° C. As one general, non-limiting example, the binder may be styrene-acrylate (SA). As another general, non-limiting example, the binder may be a mixture of binders that includes styrene-acrylate (SA). Other aqueous binders are also contemplated, such as styrene-butadiene rubber (SBR), ethylene acrylic acid (EAA), polyvinyl acetate (PVAC), polyvinyl acrylic, polyester dispersion, and combinations thereof.

In an example, the first and second aqueous barrier coatings 130, 140 each has a two-layer barrier coating with a coat weight ranging from about 6.0 lb/3 msf to about 10.0 lb/3 msf, such as from about 7.5 lb/3 msf to about 7.8 lb/3 msf, for the first layer 130A, 140A (see FIG. 2), and a coat weight ranging from about 2.0 lb/3 msf to about 6.0 lb/3 msf, such as from about 2.8 lb/3 msf to about 5.0 lb/3 msf, for the second layer 130B, 140B (see FIG. 2). In an example, the bottom wall 104 has a first layer coat weight ranging from about 9 lb/3 msf to about 12.5 lb/msf. In an example, the bottom wall 104 has a second layer coat weight ranging from about 2.1 lb/3 msf to about 5.1 lb/msf. Three or more layers may also be used without departing from the scope of the present disclosure.

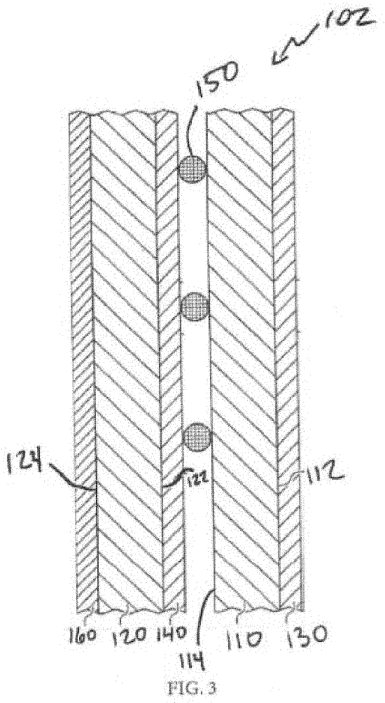

FIG. 3 illustrates an exemplary cross-sectional view of a double-wall paperboard structure of sidewall 102. In an example, sidewall 102 is comprised of an inner paperboard substrate 110 and an outer paperboard substrate 120. Inner paperboard substrate 110 may be coated with a first aqueous barrier coating 130. The first aqueous barrier coating 130 may be located on an inside surface 112 of the inner paperboard substrate 110. Outer paperboard substrate 120 may be coated with a second aqueous barrier coating 140. Second aqueous barrier coating 140 may be located on an interior surface 122 of outer paperboard substrate 120. In an example, first aqueous barrier coating 130 is heat sealable. When heated, a heat sealable coating provides an adhesion to other regions of product with which it contacts.

A top coat layer 160 may be applied to the exterior surface 124 of the outer paperboard substrate 120 using any suitable method, such as one or more coater. The top coat layer 160 may include a binder and a pigment. The pigments and binders useful for the first aqueous barrier coating 130 and second aqueous barrier coating 140 may also be used in top coat layer 160. In an example, the ratio of the binder to the pigment in the top coat layer 160 may be about 1:1 to about 1:10 by weight. In an example, the ratio of the binder to the pigment in the top coat layer 160 may be about 1:2 to about 1:8 by weight. In an example, the ratio of the binder to the pigment in the top coat layer 160 may be about 1:2.5 to about 1:5 by weight.

An adhesive 150 may be located between inner paperboard substrate 110 and outer paperboard substrate 120. Adhesive 150 may be configured to couple inner paperboard substrate 110 with outer paperboard substrate 120. In an example, adhesive 150 is glue. Adhesive 150 may be applied in generally circular drops along an outside surface 114 of the inner paperboard substrate 110. In an example, adhesive 150 may be applied as a single layer along outside surface 114 of the inner paperboard substrate 110.

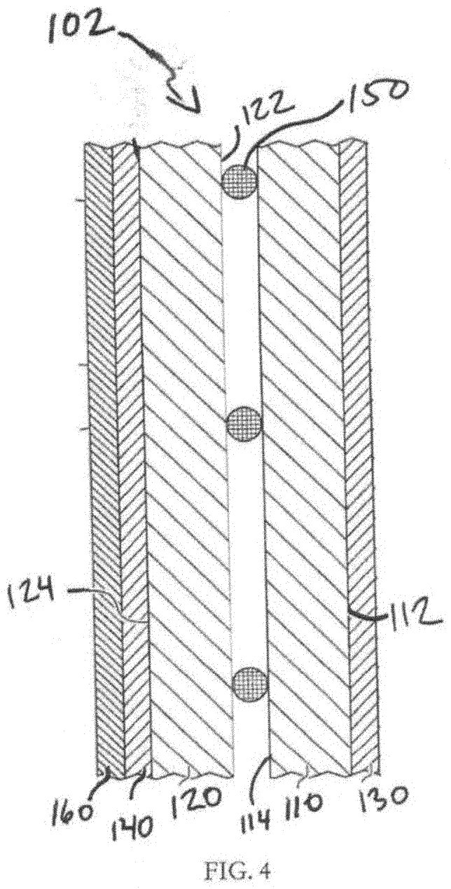

FIG. 4 illustrates an exemplary cross-sectional view of a double-wall paperboard structure of sidewall 102. In an example, sidewall 102 is comprised of an inner paperboard substrate 110 and an outer paperboard substrate 120. Inner paperboard substrate 110 may be coated with a first aqueous barrier coating 130. The first aqueous barrier coating 130 may be located on an inside surface 112 of the inner paperboard substrate 110. Outer paperboard substrate 120 may be coated with a second aqueous barrier coating 140. Second aqueous barrier coating 140 may be located on an exterior surface 124 of outer paperboard substrate 120. In an example, first aqueous barrier coating 130 is heat sealable.

A top coat layer 160 may be applied to the exterior surface 124 of the outer paperboard substrate 120 over the second aqueous barrier coating 140 using any suitable method, such as one or more coater. The top coat layer 160 may include a binder and a pigment. The pigments and binders useful for the first aqueous barrier coating 130 and second aqueous barrier coating 140 may also be used in top coat layer 160. In an example, the ratio of the binder to the pigment in the top coat layer 160 may be about 1:1 to about 1:10 by weight. In an example, the ratio of the binder to the pigment in the top coat layer 160 may be about 1:2 to about 1:8 by weight. In an example, the ratio of the binder to the pigment in the top coat layer 160 may be about 1:2.5 to about 1:5 by weight.

An adhesive 150 may be located between inner paperboard substrate 110 and outer paperboard substrate 120. Adhesive 150 may be configured to couple inner paperboard substrate 110 with outer paperboard substrate 120. In an example, adhesive 150 is glue. Adhesive 150 may be applied in generally circular drops along an outside surface 114 of the inner paperboard substrate 110. In an example, adhesive 150 may be applied as a single layer along outside surface 114 of the inner paperboard substrate 110.

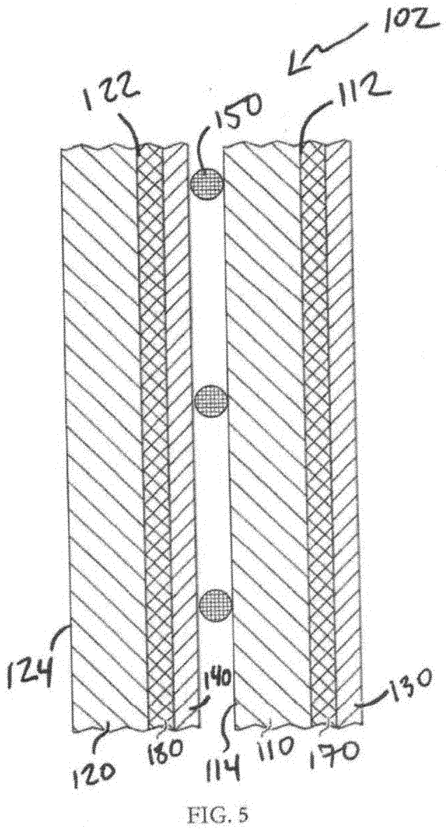

FIG. 5 illustrates an exemplary cross-sectional view of a double-wall paperboard structure of sidewall 102. In an example, sidewall 102 is comprised of an inner paperboard substrate 110 and an outer paperboard substrate 120. Inner paperboard substrate 110 may be coated with a first aqueous barrier coating 130. The first aqueous barrier coating 130 may be located on an inside surface 112 of the inner paperboard substrate 110 over a first base coating 170 located between the inner paperboard substrate 110 long the inside surface 112 and the first aqueous barrier coating 130. Outer paperboard substrate 120 may be coated with a second aqueous barrier coating 140. Second aqueous barrier coating 140 may be located on an interior surface 122 of outer paperboard substrate 120 over a second base coating 180 located between the outer paperboard substrate 120 along the interior surface 122 and the second aqueous barrier coating 140. In an example, first aqueous barrier coating 130 is heat sealable.

The first base coating 170 and second base coating 180 may be applied by a suitable method such as one or more coaters. The first base coating 170 and second base coating 180 may include similar ingredients as the first aqueous barrier coating 130 and second aqueous barrier coating 140, namely a binder and a pigment. However, in an example, the ratios may be different, namely, a ratio of the binder to the pigment in the base coating may be about 15:100 to about 45:100 by weight.

An adhesive 150 may be located between inner paperboard substrate 110 and outer paperboard substrate 120. Adhesive 150 may be configured to couple inner paperboard substrate 110 with outer paperboard substrate 120. In an example, adhesive 150 is glue. Adhesive 150 may be applied in generally circular drops along an outside surface 114 of the inner paperboard substrate 110. In an example, adhesive 150 may be applied as a single layer along outside surface 114 of the inner paperboard substrate 110.

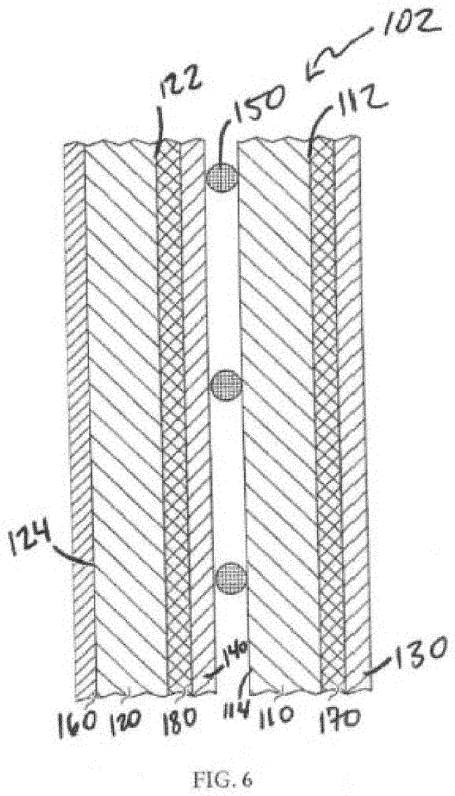

FIG. 6 illustrates an exemplary cross-sectional view of a double-wall paperboard structure of sidewall 102. In an example, sidewall 102 is comprised of an inner paperboard substrate 110 and an outer paperboard substrate 120. Inner paperboard substrate 110 may be coated with a first aqueous barrier coating 130. The first aqueous barrier coating 130 may be located on an inside surface 112 of the inner paperboard substrate 110 over a first base coating 170 located between the inner paperboard substrate 110 along the inside surface 112 and the first aqueous barrier coating 130. Outer paperboard substrate 120 may be coated with a second aqueous barrier coating 140. Second aqueous barrier coating 140 may be located on an interior surface 122 of outer paperboard substrate 120 over a second base coating 180 located between the outer paperboard substrate 120 along the interior surface 122 and the second aqueous barrier coating 140. In an example, first aqueous barrier coating 130 is heat sealable.

The first base coating 170 and second base coating 180 may be applied by a suitable method such as one or more coaters. The first base coating 170 and second base coating 180 may include similar ingredients as the first aqueous barrier coating 130 and second aqueous barrier coating 140, namely a binder and a pigment. However, in an example, the ratios may be different, namely, a ratio of the binder to the pigment in the base coating may be about 15:100 to about 45:100 by weight.

A top coat layer 160 may be applied to the exterior surface 124 of the outer paperboard substrate 120 using any suitable method, such as one or more coater. The top coat layer 160 may include a binder and a pigment. The pigments and binders useful for the first aqueous barrier coating 130 and second aqueous barrier coating 140 may also be used in top coat layer 160. In an example, the ratio of the binder to the pigment in the top coat layer 160 may be about 1:1 to about 1:10 by weight. In an example, the ratio of the binder to the pigment in the top coat layer 160 may be about 1:2 to about 1:8 by weight. In an example, the ratio of the binder to the pigment in the top coat layer 160 may be about 1:2.5 to about 1:5 by weight.

An adhesive 150 may be located between inner paperboard substrate 110 and outer paperboard substrate 120. Adhesive 150 may be configured to couple inner paperboard substrate 110 with outer paperboard substrate 120. In an example, adhesive 150 is glue. Adhesive 150 may be applied in generally circular drops along an outside surface 114 of the inner paperboard substrate 110. In an example, adhesive 150 may be applied as a single layer along outside surface 114 of the inner paperboard substrate 110.

FIG. 7 illustrates a flow chart of a method 200. Method 200 discloses an example of manufacturing a double-wall cup having an inner paperboard substrate 110 coated with a first aqueous barrier coating 130 and an outer paperboard substrate 120 coated with a second aqueous barrier coating 140. In an example, the method 200 comprises forming 210 a cup structure with the inner paperboard substrate 110. In an example, the method 200 comprises applying 220 an adhesive 150 to the cup structure. Adhesive 150 may be configured to couple inner paperboard substrate 110 with outer paperboard substrate 120. In an example, adhesive 150 is glue. Adhesive 150 may be applied in generally circular drops along an outside surface 114 of the inner paperboard substrate 110. In an example, adhesive 150 may be applied as a single layer along outside surface 114 of the inner paperboard substrate 110.

In an example, the method 200 comprises overwrapping 230 the cup structure with the outer paperboard substrate 120. The inner paperboard substrate 110 of method 200 may be coated with a first aqueous barrier coating 130. The first aqueous barrier coating 130 may be located on an inside surface 112 of the inner paperboard substrate 110 over a first base coating 170 located between the inner paperboard substrate 110 along the inside surface 112 and the first aqueous barrier coating 130. Outer paperboard substrate 120 may be coated with a second aqueous barrier coating 140. Second aqueous barrier coating 140 may be located on an interior surface 122 of outer paperboard substrate 120 over a second base coating 180 located between the outer paperboard substrate 120 along the interior surface 122 and the second aqueous barrier coating 140. In an example, first aqueous barrier coating 130 is heat sealable.

The first base coating 170 and second base coating 180 may be applied by a suitable method such as one or more coaters. The first base coating 170 and second base coating 180 may include similar ingredients as the first aqueous barrier coating 130 and second aqueous barrier coating 140, namely a binder and a pigment. However, in an example, the ratios may be different, namely, a ratio of the binder to the pigment in the base coating may be about 15:100 to about 45:100 by weight.

A top coat layer 160 may be applied to the exterior surface 124 of the outer paperboard substrate 120 using any suitable method, such as one or more coater. The top coat layer 160 may include a binder and a pigment. The pigments and binders useful for the first aqueous barrier coating 130 and second aqueous barrier coating 140 may also be used in top coat layer 160. In an example, the ratio of the binder to the pigment in the top coat layer 160 may be about 1:1 to about 1:10 by weight. In an example, the ratio of the binder to the pigment in the top coat layer 160 may be about 1:2 to about 1:8 by weight. In an example, the ratio of the binder to the pigment in the top coat layer 160 may be about 1:2.5 to about 1:5 by weight.

At this point, those skilled in the art will appreciate that various layers may be incorporated into the various paperboard structures described herein to form the bottom wall 104, without departing from the scope of the present disclosure.

### EXPERIMENTAL EXAMPLES

Experiments were conducted to evaluate the use of a double-wall structure having two paperboard substrates coated in an aqueous barrier coating as described herein. Three barrier coating formulations (BC-1, BC-2, and BC-3) and one non-barrier coating formulation (NBC-1) were prepared and used in the experiments. The raw materials used in the aqueous barrier coatings in the experiments are presented in Table 1. The aqueous barrier coating formulations used in the experiments, including the amount of pigments and binders of Table 1, are presented in Table 2. The paperboard assemblies used in the experiments are presented in Table 3. The container samples used and tested in the experiments are presented in Table 4.

TABLE 1

| Type | Name | Product | Description |
|---|---|---|---|
| Pigment | CC-1 | HYDROCARB ® 60 | Coarse ground CaCO₃ |
| | | (Omya AG, | (particle size 60% < 2 micron) |
| | | Oftringen, Switzerland) | |
| Pigment | CC-2 | HYDROCARB ® 90 | Fine ground CaCO₃ |
| | | (Omya AG, | (particle size 90% < 2 micron) |
| | | Oftringen, Switzerland) | |
| Pigment | CL-1 | BARRISURF ™ XP | platy clay with high aspect |
| | | (IMERYS | ratio |
| | | Kaolin, Georgia) | |
| Pigment | CL-2 | HYDRAFINE ® 90W | kaolin clay No. 1 ultrafine |
| | | (KaMin LLC of | clay |
| | | Macon, Georgia) | |
| Binder | SA-1 | CARTASEAL ® SCR | Water based acrylic emulsion |
| | | (Archroma, | polymer, Tg of 30° C. |
| | | Reinach, Switzerland) | |
| Binder | SA-2 | RHOPLEXTM C-340 | Water based styrene-acrylic |
| | | (The Dow Chemical | latex polymer, Tg of 8° C. |
| | | Company, Michigan) | |

TABLE 2

| | | | | Non-Barrier |
|---|---|---|---|---|
| Formulation | Barrier Coating (BC) | | | Coating (NBC) |
| (in Parts) | BC-1 | BC-2 | BC-3 | NBC-1 |
| CaCO3 (CC-1) | 65 | | | |
| CaCO3 (CC-2) | | | | 50 |
| Clay (CL-1) | 35 | | 50 | |
| Clay (CL-2) | | 100 | 50 | 50 |
| Binder (SA-1) | 250 | 250 | 250 | |
| Binder (SA-2) | | | | 25 |

TABLE 3

| | Coated Paperboard ID | | | | | |
|---|---|---|---|---|---|---|
| | SW-1 | SW-2 | SW-3 | BS-1 | BS-2 | |
| Substrate | 18 pt, 185 | | | 13 pt, 150 | 11 pt, 140 | |
| | lb/3000F2, | | | lb/3000F2, | lb/3000F2, | |
| | TruServ ™ | | | TruServ ™ | TruServ ™ | |
| | Cupstock | | | Cupstock | Cupstock | |
| Side Coated | felt | felt | felt | felt | felt | wire |
| 1^{st} Layer | BC-1 | BC-1 | BC-3 | BC-1 | BC-1 | BC-1 |
| Barrier Coat | | | | | | |
| 1^{st} Layer | 7.7 | 7.8 | 7.5 | 8.5 | 9.0 | 12.5 |
| Barrier Coat | | | | | | |
| Weight | | | | | | |
| (lb/3 msf) | | | | | | |
| 2^{nd} Layer | BC-2 | BC-1 | BC-2 | BC-2 | BC-1 | NBC-1 |
| Barrier Coat | | | | | | |
| 2^{nd} Layer | 4.8 | 2.8 | 5.0 | 5.1 | 2.1 | 3.8 |
| Barrier Coat | | | | | | |
| Weight | | | | | | |
| (lb/3 msf) | | | | | | |
| H₂O Cobb | 4.8 | 3.8 | 5.2 | 4.2 | 2.9 | 6.5 |
| (g/m2- | | | | | | |
| 30 min) | | | | | | |

| | | | | | |
|---|---|---|---|---|---|
| WVTR | 306 | 351 | 349 | 292 | 170 |
| (g/m2-day, | | | | | |
| tropical) | | | | | |

TABLE 4

| Test Cup Sample ID | | Control 1 | Control 2 | Example 1 | Example 2 | Example 3 |
|---|---|---|---|---|---|---|
| Primary | Side | SW-1 | SW-1 | SW-1 | SW-3 | SW-2 |
| Cup | Wall | | | | | |
| | Bottom | BS-1 | BS-1 | BS-1 | BS-1 | BS-2 |
| | Stock | | | | | |

| | | | | | |
|---|---|---|---|---|---|
| Overwrap | None; but with a | Uncoated, | SW-1 | SW-3 | SW-3 |
| | small piece of | 18 pt, | (coated) | (coated) | (coated) |
| | Scotch tape | TruServ ™ | | | |
| | attached to the | Paperboard | | | |
| | external surface | | | | |

The various formulations of aqueous barrier coatings were applied to 18 pt, 13 pt, and 11 pt solid bleached sulfate (SBS) cupstock, or paperboard. The various aqueous barrier coatings used in the experiments were applied by a blade coater. The primary cups of Table 4 were made on a pilot cup former manufactured by Paper Machinery Corporation (PMC model 1250).

The overwrap procedure was conducted under the following conditions. First, primary, single wall cups were made on a pilot cup former (PMC model 1250). Then, some cups were overwrapped by hand using a piece of paperboard, coated or uncoated, which was pre-cut to similar shape as the cup side-wall blank. A small drop of conventional hot melt glue was placed each on the top, middle, and bottom of the primary cup sidewall where the overwrap started. Then, the top side of the overwrap was aligned below the rim of the cup, and pressure was applied on the glue spots to set the glue. Two small drops of hot melt glue were then applied at the top and bottom of the cup sidewall approximately 45° (or ⅛ of circle) from the start point, followed by setting the glue by applying pressure on the overwrap at the glue points. In some instances, an extra drop of glue was applied at the middle position similar as the first three-drop glue pattern. Double-wall or overwrapped cups were formed by repeating the step above until the overwrap was completely wrapped around the primary cup. Accordingly, a total of isolated 18 to 24 glue points were placed between the primary cup and the outer wall to secure the overwrap with an air gap of approximately 0.5-1 mm.

Water barrier effectiveness of the coatings in each Example was evaluated by water Cobb (TAPPI Standard T441 om-04) in g/m2 per 30 minutes, using 23° C. water. In other words, the Cobb test determines how much water is absorbed after 30 minutes. Water vapor barrier properties were tested and evaluated via the following test conditions: WVTR (water vapor transmission rate) at conditions of 38° C. and 90% relative humidity (TAPPI Standard T464 OM-12). Cup liquid holdout testing was conducted with Coca-Cola™. Coca-Cola™, Original, ˜4° C., was poured from 12 fluid-ounce cans into Example and Control test cups to a level of approximately 10 mm below the rim of the cup. The cups containing Coca-Cola™ were then put into an environmental chamber pre-set at 49° C. and 50% relative humidity. After 4 hours, the cups were emptied and then immediately evaluated for staining, leakage, and damage.

In an aspect, the coated paperboard of the present description has a water vapor transmission rate of less than 500 grams per square meter per day. In another aspect, the coated paperboard of the present description has a water vapor transmission rate of less than 400 grams per square meter per day. In yet another aspect, the coated paperboard of the present description has a water vapor transmission rate of less than 300 grams per square meter per day. In yet another aspect, the coated paperboard of the present description has a water vapor transmission rate of less than 200 grams per square meter per day. The moisture vapor barrier is evaluated by WVTR (water vapor transmission rate) at 38° C. and 90% relative humidity following TAPPI Standard T464 OM-12.

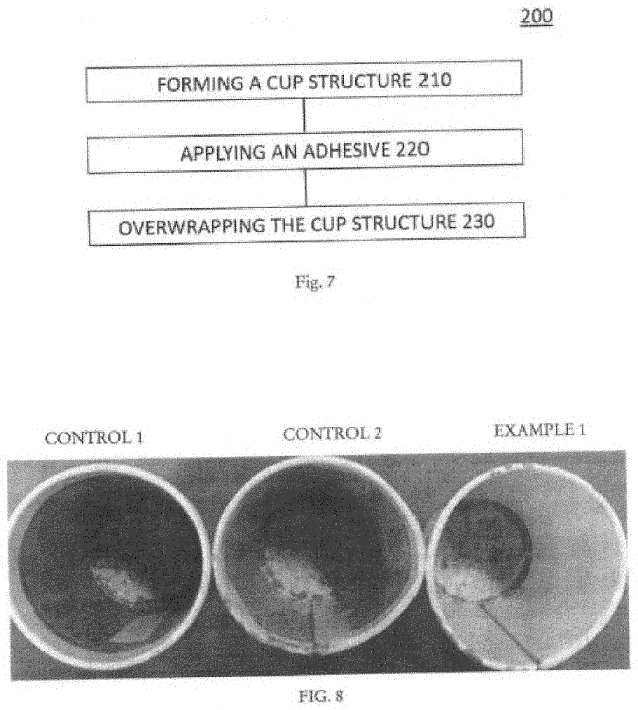

Each Control and Example was photographed at the end of the experiments to compare the amount of staining on the interior, or felt, wall and exterior, or wire, wall of the sidewall 102. As illustrated in FIG. 8, both Control 1 (primary cup without any overwrap) and Control 2 (primary cup with an un-coated paperboard overwrap) exhibited significant staining on the interior walls of the cups. Control 1 did not exhibit staining, however, in the rectangular section where a piece of Scotch™ tape was placed on the exterior wall. Example 1, using the same primary cup as Control 1 and Control 2 but having an additional overwrap using coated paperboard side wall (SW)-1 with a first layer of aqueous barrier coating BC-1 and a second layer of aqueous barrier coating BC-2, exhibited significantly less staining in the visual inspection as shown in FIG. 8.

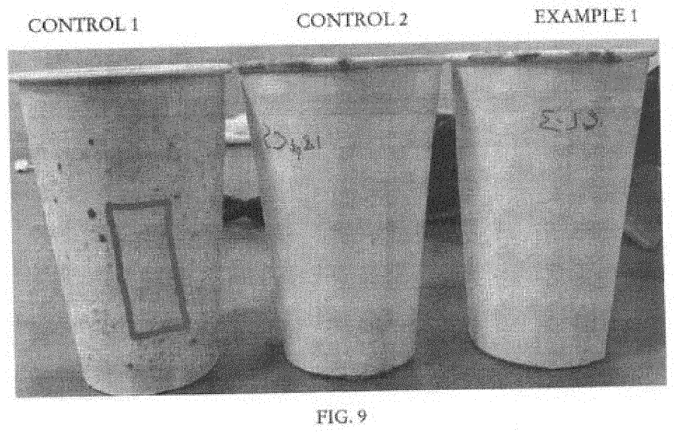

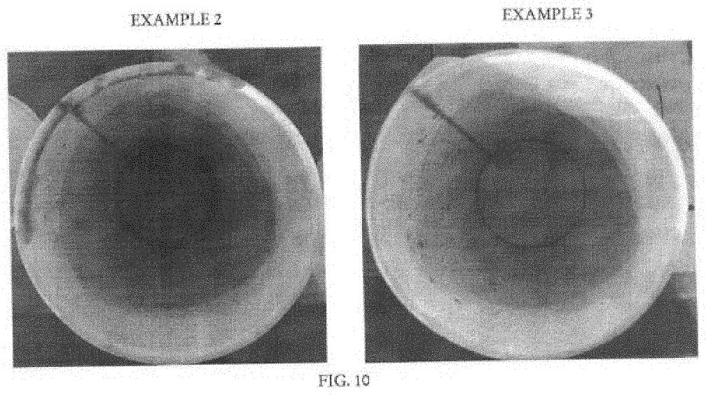

FIG. 9 illustrates the amount of staining exhibited on the exterior surface 114 of Control 1 and the exterior surface 124 of Control 2 and Example 1. As can be seen in FIG. 9, Control 1 exhibited significant staining along exterior surface 114 surrounding the taped section but not within the taped section. Control 2 and Example 1 show minimal to no staining on each respective exterior surface 124. FIG. 10 illustrates the results of visual testing in Example 2 and Example 3 having an overwrap of side wall (SW)-3, which both showed minimal staining on interior surface in the visual inspection. As in a control test, the primary cup of Example 2 without an overwrap showed significant staining on both internal surface and external surface of the cups. Also, as shown in FIG. 10, moderate staining occurred in Example 2 along the bottom of the cup but no or minimum staining occurred in Example 3 along the bottom of the cup, which was likely because of the cup bottom stock (BS)-2 in Example 3 having barrier coating on both sides, thus reducing the liquid absorption and transmission.

Although various aspects of the disclosed heat sealable paperboard structures and associated paperboard-based containers have been shown and described, modifications may occur to those skilled in the art upon reading the specification. The present application includes such modifications and is limited only by the scope of the claims.

What is claimed is:

1. A coated paperboard container, comprising:
an inner paperboard substrate;
an outer paperboard substrate;
a first aqueous barrier coating located on the inner paperboard substrate; and
a second aqueous barrier coating located on the outer paperboard substrate.

2. The coated paperboard container of claim 1 wherein the inner paperboard substrate and the outer paperboard substrate are coupled with an adhesive.

3. The coated paperboard container of claim 1 comprising a first base coating located between the inner paperboard substrate and the first aqueous barrier coating.

4. The coated paperboard container of claim 1 comprising a second base coating located between the outer paperboard substrate and the second aqueous barrier coating.

5. The coated paperboard container of claim 1 wherein the second aqueous barrier coating is located on an interior surface of the outer paperboard substrate.

6. The coated paperboard container of claim 1 wherein the second aqueous barrier coating is located on an exterior surface of the outer paperboard substrate.

7. The coated paperboard container of claim 1 wherein the first aqueous barrier coating is located on an inside surface of the inner paperboard substrate.

8. The coated paperboard container of claim 1 comprising a top coat layer located on an exterior surface of the outer paperboard substrate.

9. The coated paperboard container of claim 6 comprising a top coat layer located on the second aqueous barrier coating.

10. The coated paperboard container of claim 1 wherein the outer paperboard substrate comprises solid bleached sulfate.

11. The coated paperboard container of claim 1 wherein the inner paperboard substrate comprises solid bleached sulfate.

12. The coated paperboard container of claim 1 wherein the outer paperboard substrate has a basis weight ranging from about to about 140 lb/3000 ft² to about 185 lb/3000 ft².

13. The coated paperboard container of claim 1 wherein the paperboard substrate has a basis weight ranging from about to about 120 lb/3000 ft² to about 200 lb/3000 ft².

14. The coated paperboard container of claim 1 wherein:
the first aqueous barrier coating comprises a first layer and a second layer, and
the second aqueous barrier coating comprises a first layer and a second layer.

15. The coated paperboard container of claim 14 wherein:
the first layer of the first aqueous barrier coating has a coat weight ranging from about 6.0 lb/3 msf to about 10.0 lb/3 msf, and
the first layer of the second aqueous barrier coating has a coat weight ranging from about 6.0 lb/3 msf to about 10.0 lb/3 msf.

16. The coated paperboard container of claim 14 wherein:
the first layer of the first aqueous barrier coating has a coat weight ranging from about 7.5 lb/3 msf to about 7.8 lb/3 msf, and
the first layer of the second aqueous barrier coating has a coat weight ranging from about 7.5 lb/3 msf to about 7.8 lb/3 msf.

17. The coated paperboard container of claim 14 wherein:
the second layer of the first aqueous barrier coating has a coat weight ranging from about 2.0 lb/3 msf to about 6.0 lb/3 msf, and
the second layer of the second aqueous barrier coating has a coat weight ranging from about 2.0 lb/3 msf to about 6.0 lb/3 msf.

18. The coated paperboard container of claim 14 wherein:
the second layer of the first aqueous barrier coating has a coat weight ranging from about 2.8 lb/3 msf to about 5.0 lb/3 msf, and
the second layer of the second aqueous barrier coating has a coat weight ranging from about 2.8 lb/3 msf to about 5.0 lb/3 msf.

19. The coated paperboard container of claim 1 wherein the first aqueous barrier coating comprises binder and pigment.

20. The coated paperboard container of claim 1 wherein the second aqueous barrier coating comprises binder and pigment.

21. The coated paperboard container of claim 19 wherein the binder comprises styrene-acrylate.

22. The coated paperboard container of claim 20 wherein the binder comprises styrene-acrylate.

23. The coated paperboard container of claim 19 wherein the pigment comprises kaolin clay.

24. The coated paperboard container of claim 20 wherein the pigment comprises kaolin clay.

25. The coated paperboard container of claim 19 wherein the pigment comprises CaCO₃.

26. The coated paperboard container of claim 20 wherein the pigment comprises CaCO₃.

27. The coated paperboard container of claim 1 wherein the inner paperboard substrate and outer paperboard substrate have a 30-minute-water-Cobb rating of at most about 3.8 g/m².

28. The coated paperboard container of claim 1 wherein the inner paperboard substrate and outer paperboard substrate have a 30-minute-water-Cobb rating of at most about 4.8 g/m².

29. The coated paperboard container of claim 1 wherein the inner paperboard substrate and outer paperboard substrate have a 30-minute-water-Cobb rating of at most about 5.2 g/m².

30. The coated paperboard container of claim 1 wherein the inner paperboard substrate and outer paperboard substrate have a 30-minute-water-Cobb rating of at most about 10.0 g/m².

31. The coated paperboard container of claim 1 wherein the inner paperboard substrate and outer paperboard substrate have a water vapor transmission rate of at most about 200 g/m2-day.

32. The coated paperboard container of claim 1 wherein the inner paperboard substrate and outer paperboard substrate have a water vapor transmission rate of at most about 300 g/m2-day.

33. The coated paperboard container of claim 1 wherein the inner paperboard substrate and outer paperboard substrate have a water vapor transmission rate of at most about 400 g/m2-day.

34. The coated paperboard container of claim 1 wherein the inner paperboard substrate and outer paperboard substrate have a water vapor transmission rate of at most about 500 g/m2-day.

35. A method of manufacturing a double-wall cup having an inner paperboard substrate coated with a first aqueous barrier coating and an outer paperboard substrate coated with a second aqueous barrier coating, the method comprising:
forming a cup structure with the inner paperboard substrate;
applying an adhesive to the cup structure; and
overwrapping the cup structure with the outer paperboard substrate.

36. The method of claim 35 wherein the adhesive is glue.

37. The method of claim 35 wherein the inner paperboard substrate comprises solid bleached sulfate.

38. The method of claim 35 wherein the outer paperboard substrate comprises solid bleached sulfate.

39. The method of claim 35 wherein the first aqueous barrier coating comprises binder and pigment.

40. The method of claim 35 wherein the second aqueous barrier coating comprises binder and pigment.

41. The method of claim 39 wherein the binder comprises styrene-acrylate.

42. The method of claim 40 wherein the binder comprises styrene-acrylate.

43. The method of claim 35 wherein the second aqueous barrier coating is located on an interior surface of the outer paperboard substrate.

44. The method of claim 35 wherein in the second aqueous barrier coating is located on an exterior surface of the outer paperboard substrate.

45. The method of claim 35 wherein the first aqueous barrier coating is located on an inside surface of the inner paperboard substrate.

46. A double wall cup comprising:
an inner paperboard substrate;
an outer paperboard substrate;
a first aqueous barrier coating located on the inner paperboard substrate;
a second aqueous barrier coating located on the outer paperboard substrate; and
an adhesive located between the inner paperboard substrate and the outer paperboard substrate.

47. The double wall cup of claim 46 comprising a first base coating located between the inner paperboard substrate and the first aqueous barrier coating.

48. The double wall cup of claim 46 comprising a second base coating located between the outer paperboard substrate and the second aqueous barrier coating.

49. The double wall cup of claim 46 wherein the second aqueous barrier coating is located on an interior surface of the outer paperboard substrate.

50. The double wall cup of claim 46 wherein the second aqueous barrier coating is located on an exterior surface of the outer paperboard substrate.

51. The double wall cup of claim 46 wherein the first aqueous barrier coating is located on an inside surface of the inner paperboard substrate.

52. The double wall cup of claim 46 comprising a top coat layer located on an exterior surface of the outer paperboard substrate.

53. The double wall cup of claim 46 comprising a top coat layer located on the second aqueous barrier coating.

54. The double wall cup of claim 46 wherein the outer paperboard substrate comprises solid bleached sulfate.

55. The double wall cup of claim 46 wherein the inner paperboard substrate comprises solid bleached sulfate.
